(19) United States
(12) Patent Application Publication
(10) Pub. No.: US 2013/0071093 A1
(43) Pub. Date: Mar. 21, 2013

(54) MAINTAINING VIEWER ACTIVITY INFORMATION OF A RECORDED PROGRAM FOR PROGRAM DELETION DECISIONS

(71) Applicants: William Turner Hanks, Carol Stream, IL (US); Gina Marie Hanks, Carol Stream, IL (US)

(72) Inventors: William Turner Hanks, Carol Stream, IL (US); Gina Marie Hanks, Carol Stream, IL (US)

(21) Appl. No.: 13/234,372

(22) Filed: Sep. 16, 2011

(51) Int. Cl. H04N 5/76

(52) U.S. Cl. 386/295; 386/E05.001

(57) ABSTRACT

Methods and apparatuses for maintaining viewer activity information of a recorded program for program deletion decisions are provided. Viewer activity information for a recorded program is collected and can be displayed automatically or on request at delete decision time. Viewer activity information can be collected manually or automatically. Program deletion can be manual or automatic based on the viewer activity information.

### TECHNICAL FIELD

This disclosure is related to viewer activity information of recorded programs.

### BACKGROUND

A cable-based system, for example, can be used to deliver video over an existing cable television network to a DVR. The cable television network can take the form of an all-coax, all-fiber, or hybrid fiber/coax (HFC) network. A multiple service operator (MSO) can deliver video from a video server to customer premise equipment (CPE) devices located at subscriber premises. The CPE devices can include, for example, cable modems (CMs) or embedded multimedia terminal adapters (eMTAs), settop boxes, gateway devices, among others. A subscriber can record a delivered video on a digital video record (“DVR”) such as a settop box or gateway device, for example, for viewing at a later time.

DVRs have limited storage space and, therefore, can only store a limited number of recorded programs. A user can manually delete a recorded program to make storage space available for future recordings. In some DVRs, older recorded programs can be automatically deleted when space is needed for a recording. To prevent a DVR from automatically deleting a program that has not been viewed, some DVRs allow a user to flag a program for manual deletion only so that the flagged program is not deleted automatically when space is needed. Regardless of whether a program is deleted manually or automatically, a DVR can require confirmation prior to deleting the program. Still further, a DVR may prompt a user to delete a recorded program after the program has been watched.

When deciding on whether to delete program, a user may need to consult with other prospective viewers of the program to determine whether they have viewed the program. If the user determines after consulting with all the other prospective viewers that they all have not viewed the program, then the user may decide not to delete the program; if they all have viewed the program, then the user may decide to delete the program.

One problem with the above approach for determining whether to delete a program is that all of the prospective viewers may not be available at delete decision time to advise the user of whether they have viewed the program. In that case, the user must make an uninformed decision on whether to delete the program. Another problem with the above approach is that it can be time consuming to determine whether all the prospective viewers have viewed the program.

### BRIEF DESCRIPTION OF THE DRAWINGS

FIG. 1 is a block diagram illustrating an example cable-based system operable to deliver video over an existing cable television network to a DVR.

FIG. 2 is a flowchart illustrating an example process for maintaining viewer activity information of a recorded program for program deletion decisions.

FIG. 3 is a block diagram illustrating an example device operable to maintain viewer activity information of a recorded program for program deletion decisions.

### DETAILED DESCRIPTION

Various implementations of this disclosure maintain viewer activity information of a recorded program for program deletion decisions. Although this disclosure makes reference to a cable-based system and CPE devices such as settop boxes or gateway devices, this disclosure is not intended to be limited to a cable-based system or any particular CPE device. It should be understood that the concepts disclosed herein can be applied to any wired or wireless communication systems or a combination of the foregoing and any digital video recording device including, but not limited to, settop boxes, gateway devices, network-based devices, cloud-based devices or any other device that stores video.

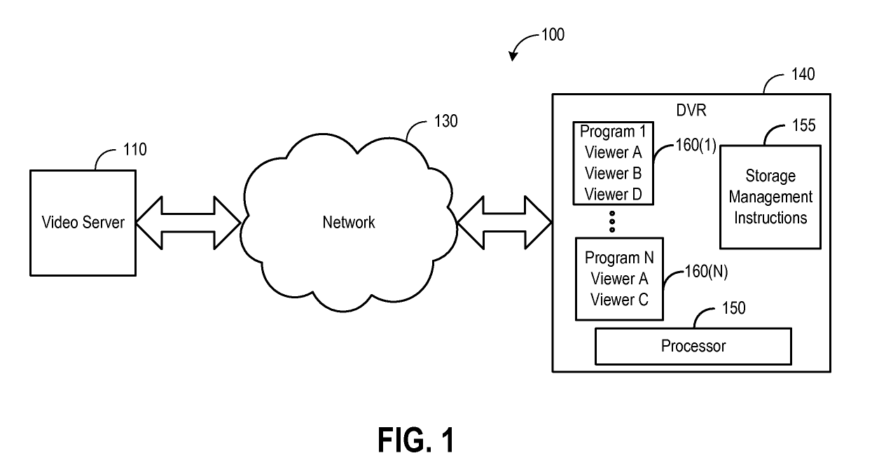

FIG. 1 illustrates an example cable-based system 100 operable to deliver video over an existing cable television network to a DVR such as a settop box or gateway device. As shown in FIG. 1, video can be transferred over a cable network 130 from a video server 110 to a DVR 140.

As discussed above, DVRs have limited storage space and, therefore, can only store a limited number of recorded programs. Accordingly, sometimes a program needs to be deleted when space is needed for a recording, for example. When deciding whether to delete a program, a user may need to consult with other prospective viewers of the program to determine whether they have viewed the program. However, this approach can be inconvenient or inefficient. Thus, it can be desirable to track who has viewed a recorded program so that at the moment of delete decision, viewer activity information can be retrieved and a determination on whether to delete the program can be made without consulting other prospective viewers. To this end, the DVR 140 can contain a processor 150 for executing DVR storage management instructions 155 to maintain viewer activity information of recorded programs.

The storage management instructions 155 when executed (for example, via a remote control) can launch a user interface to collect viewer activity information. For example, in one implementation, the user interface can permit a user to enter identifying information of the prospective viewers of recorded programs on the DVR. The processor 150 executing DVR storage management instructions 155 can store this identifying information for later use, as will be described. When a user views a recorded program on the DVR, the processor 150 executing DVR storage management instructions 155 can display the list of prospective viewers on the user interface and prompt the viewer to indicate that the viewer has viewed the program by, for example, marking a box next to the viewer's identifying information. In this way, the DVR storage management instructions 155 can maintain viewer activity information for the recorded program. Thereafter, when the DVR prompts a user on whether to delete a recorded program, the viewer activity information for the recorded program can be retrieved and displayed. The viewer activity information can be displayed automatically or upon request. In this way, when deciding on whether to delete a recorded program, a user can review the viewer activity information to determine whether other prospective viewers of the program have viewed the program.

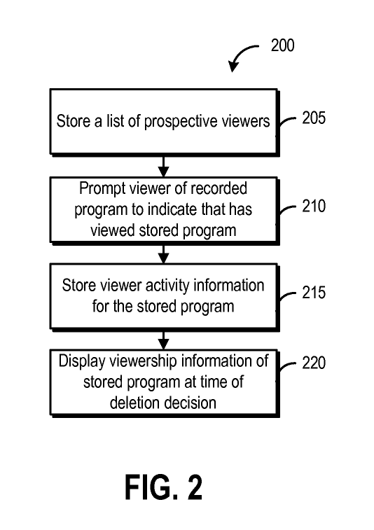

FIG. 2 illustrates an example process 200 for maintaining viewer activity information of a recorded program for program deletion decisions. At stage 205, a list of prospective viewers is recorded (for example, by processor 150 executing DVR storage management instructions 155). As discussed above, in one implementation, for example, the list of prospective viewers can be entered manually by a user. In a user login based system, for example, the list of prospective viewers can be determined (for example by the processor 150 executing DVR storage management instructions 155 of FIG. 1) based on the pre-existing user list. In some implementations, for example, each user who records a program is listed as a prospective viewer for that program. In some implementation, combinations of the foregoing examples can be used to maintain a list of prospective viewer. In some implementation, the list of prospective viewers can include devices. For example, in a gateway environment, the settop that requested recording of a program can be listed as a prospective viewer for that program.

At stage 210, each viewer of a recorded program is prompted to indicate that the viewer has viewed the recorded program. The processor 150 executing DVR storage management instructions 155, for example, can prompt the viewer. In some implementations, for example, the prompt can be provided by an electronic program guide for DVR content. In other implementations, the prompt can be provided separate from the electronic program guide. In still further implementations, the prompt can be provided on the remote control.

At stage 215, the viewer activity information for a recorded program is stored. The viewer activity information for a recorded program can be stored, for example, by a storage management program (e.g., storage management program 155 of FIG. 1), in conjunction with a data store (e.g., data store 160(1) of FIG. 1). The data store can include identification information of the viewers that have indicated they have viewed the recorded program or otherwise authorized deletion of the recorded program. In some implementations, viewer activity information can be associated with a recorded program through use of a database or via metadata of the recorded program. For example, viewer activity information can be associated with a recorded program using a data record for the recorded program, for example, using a linked-list type of structure.

At stage 220, viewer activity information of a recorded program can be retrieved and displayed at a delete decision time. The viewer activity information can be retrieved and displayed at a delete decision time, for example, by a storage management program (e.g., storage management program 155 of FIG. 1), in conjunction with a data store (e.g., data store 160(1) of FIG. 1). Thus, for example, the viewer activity information can be automatically displayed when a user is prompted on whether to delete a program. In some implementations, the viewer activity information is displayed only when the user requests the information to be displayed. In other implementations, viewer activity information can be automatically displayed or never displayed.

In some implementations, the storage management program, for example, can automatically determine which user is viewing the recorded program. This can be achieved, for example, by requiring the viewer to enter identifying information (e.g., a login or username) prior to viewing the recorded program. In various alternative implementations, a DVR, display, or remote control device can include a thumbprint scanner or a camera in conjunction with facial recognition software to automatically identify a user.

To prevent the DVR from automatically deleting a program that has not been viewed, a storage management program (e.g., storage management program 155 of FIG. 1) can facilitate entry of a deletion policy. The deletion policy can be used to identify which viewers should view the program prior to automatic deletion. In this way, when deciding on whether to automatically delete a recorded program, the storage management program can retrieved the viewer activity information to determine whether all the required viewers have reviewed the program. If it is determined that all the required viewers have not viewed the program, then the storage management program will not delete the program; if it is determined that all the required viewers have viewed the program, then the storage management program will delete the program.

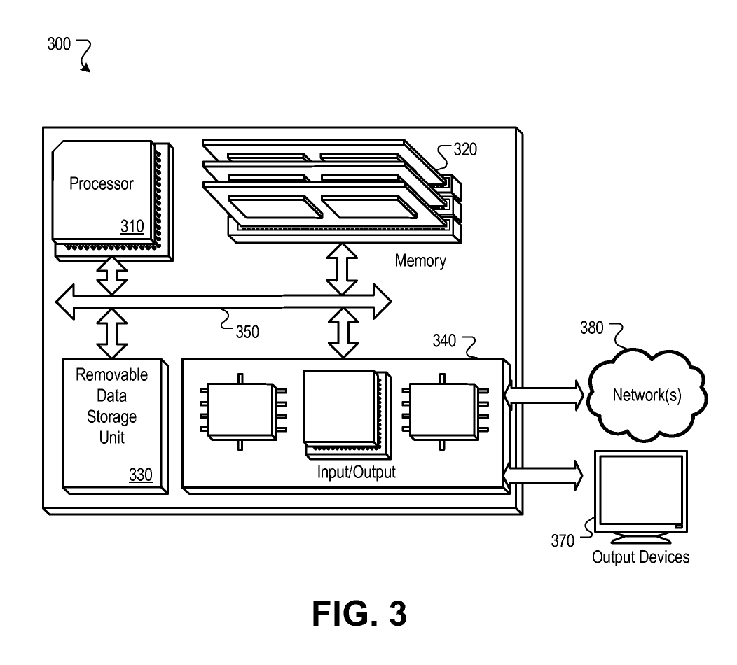

FIG. 3 illustrates a DVR 300 operable to perform the example process 200 of FIG. 2. The DVR 300 can include a processor 310, a memory 320, a data storage unit 330 (e.g., the data storage unit can be either fixed or removable), and an input/output device 340. Each of the components 310, 320, 330, and 340 can, for example, be interconnected using a system bus 350. In some implementations, the DVR 300 can include one of more interconnected boards where each board comprising components 310, 320, 330, and 340. The processor 310 is capable of processing instructions (e.g., DVR storage management instructions 155 of FIG. 1) for execution within the DVR 300. For example, the processor 310 can be capable of processing instructions for executing the process 200 of FIG. 2 in the DVR 300. In some implementations, the processor 310 is a single-threaded processor. In other implementations, the processor 310 is a multi-threaded processor. The processor 310 is capable of processing instructions recorded in the memory 320 or on the storage device 330.

The memory 320 stores information within the DVR 300. For example, memory 320 can store viewer activity information or policy rules. In some implementations, the memory 320 is a computer-readable medium. In other implementations, the memory 320 is a volatile memory unit. In still other implementations, the memory 320 is a non-volatile memory unit.

In some implementations, the storage device 330 is capable of providing mass storage for the DVR 300. In one implementation, the storage device 330 is a computer-readable medium. For example, the storage device 330 can store the recorded programs. In some implementations, the storage device 330 can store viewer activity information and/or policy rules. In some implementations, the storage device 330 is not removable. In various different implementations, the storage device 330 can, for example, include a hard disk device, an optical disk device, flash memory or some other large capacity storage device.

The input/output device 340 provides input/output operations for the DVR 300. In one implementation, the input/output device 340 can include one or more of a wireless interface, WAN/LAN network interface, such as, for example, an IP network interface device, e.g., an Ethernet card, a cellular network interface, a serial communication device, e.g., and RS-232 port, and/or a wireless interface device, e.g., an 802.11 card. In another implementation, the input/output device 340 can include driver devices configured to receive input data and send output data to other input/output devices, as well as sending communications to, and receiving communications from various networks.

Implementations of the device of this disclosure, and components thereof, can be realized by instructions that upon execution cause one or more processing devices to carry out the processes and functions described above. Such instructions can, for example, comprise interpreted instructions, such as script instructions, e.g., JavaScript or ECMAScript instructions, or executable code, or other instructions recorded in a computer readable medium.

The processes and logic flows described in this specification can be performed by one or more programmable processors executing one or more computer programs to perform functions by operating on input data and generating output thereby tying the process to a particular machine (e.g., a machine programmed to perform the processes described herein). The processes and logic flows can also be performed by, and apparatus can also be implemented as, special purpose logic circuitry, e.g., an FPGA (field programmable gate array) or an ASIC (application specific integrated circuit).

Computer readable media suitable for storing computer program instructions and data include all forms of non volatile memory, media and memory devices, including by way of example semiconductor memory devices, e.g., EPROM, EEPROM, and flash memory devices; magnetic disks, e.g., internal hard disks or removable disks; magneto optical disks; and CD ROM and DVD ROM disks. The processor and the memory can be supplemented by, or incorporated in, special purpose logic circuitry.

To provide for interaction with a user, implementations of the subject matter described in this specification can be operable to interface with a set-top-box (STB); an advanced television; or some other computing device that is integrated with or connected to (directly or indirectly) a display, e.g., a CRT (cathode ray tube) or LCD (liquid crystal display) monitor, for displaying information to the user. To provide for input by a user to the computer, implementations of the subject matter described in this specification further can be operable to interface with a keyboard, a pointing device (e.g., a mouse or a trackball), and/or a remote control device.

While this specification contains many specific implementation details, these should not be construed as limitations on the scope of any invention or of what may be claimed, but rather as descriptions of features that may be specific to particular implementations of particular inventions. Certain features that are described in this specification in the context of separate implementations can also be implemented in combination in a single implementation. Conversely, various features that are described in the context of a single implementation can also be implemented in multiple implementations separately or in any suitable subcombination. Moreover, although features may be described above as acting in certain combinations and even initially claimed as such, one or more features from a claimed combination can in some cases be excised from the combination, and the claimed combination may be directed to a subcombination or variation of a subcombination.

Similarly, while operations are depicted in the drawings in a particular order, this should not be understood as requiring that such operations be performed in the particular order shown or in sequential order, or that all illustrated operations be performed, to achieve desirable results. In certain circumstances, multitasking and parallel processing may be advantageous. Moreover, the separation of various system components in the implementations described above should not be understood as requiring such separation in all implementations, and it should be understood that the described program components and systems can generally be integrated together in a single software product or packaged into multiple software products.

Particular implementations of the subject matter described in this specification have been described. Other implementations are within the scope of the following claims. For example, the actions recited in the claims can be performed in a different order and still achieve desirable results, unless expressly noted otherwise. As one example, the processes depicted in the accompanying figures do not necessarily require the particular order shown, or sequential order, to achieve desirable results. In some implementations, multitasking and parallel processing may be advantageous.

1. A method for maintaining viewer activity information of a recorded program for program deletion decisions comprising:
storing viewer activity information for a recorded program; and
displaying the viewer activity information of the recorded program at delete decision time to aid a user in making a deletion decision for the recorded program.

2. The method of claim 1 further comprising:
prompting each viewer of the recorded program to indicate that the viewer has viewed the recorded program and storing the indication for each viewer as viewer activity information for the recorded program.

3. The method of claim 2 further comprising:
storing a list of prospective viewers;
wherein prompting each viewer of the recorded program to indicate that the viewer has viewed the recorded program comprises displaying the list of prospective viewers and prompting each viewer of the recorded program to indicate that the viewer has viewed the recorded program.

4. The method of claim 3 wherein the list of prospective viewers is generated based on manual input.

5. The method of claim 3 wherein the list of prospective viewers is generated based on a pre-existing list.

6. The method of claim 4 wherein the pre-existing list is a list of authorized users.

7. The method of claim 3 wherein the list of prospective viewers include at least one device.

8. The method of claim 1 wherein the viewer activity information for the recorded program is determined based on identifying information entered prior to display of the recorded program.

9. The method of claim 1 wherein the viewer activity information is automatically displayed when a user is prompted on whether to delete a program.

10. The method of claim 1 wherein the viewer activity information is displayed only when requested.

11. A method for maintaining viewer activity information of a recorded program for a program deletion decision comprising:
storing viewer activity information for a recorded program; and
deleting the recorded program based on the viewer activity information.

12. The method of claim 11 further comprising associating a deletion rule with the recorded program wherein the deletion rule is based on the viewer activity information and deleting the recorded program based on the deletion rule.

13. The method of claim 11 wherein the viewer activity information for the recorded program is determined based on identifying information entered prior to display of the recorded program.

14. The method of claim 11 further comprising:
storing a list of prospective viewers;
displaying the list of prospective viewers and prompting each viewer of the recorded program to indicate that the viewer has viewed the recorded program; and
storing the indication for each viewer as viewer activity information for the recorded program.

15. The method of claim 14 wherein the list of prospective viewers is generated based on manual input.

16. The method of claim 14 wherein the list of prospective viewers is generated based on a pre-existing list.

17. The method of claim 14 wherein the pre-existing list is a list of authorized users.

18. The method of claim 14 wherein the list of prospective viewers include at least one device.

19. A computer readable medium having instructions for causing a computer to execute a method for maintaining viewer activity information of a recorded program for program deletion decisions, the method comprising:
prompting each viewer of a recorded program to indicate that the viewer has viewed the recorded program; and
storing the indication for each viewer as viewer activity information for the recorded program.

20. The computer readable medium of claim 19, the method further comprising displaying the viewer activity information of the recorded program when a user is prompted on whether to delete the recorded program.

21. The computer readable medium of claim 19 wherein prompting each viewer of the recorded program to indicate that the viewer has viewed the recorded program comprises displaying the list of prospective viewers and prompting each viewer of the recorded program to indicate that the viewer has viewed the recorded program.

22. A computer readable medium having instructions for causing a computer to execute a method for maintaining viewer activity information of a recorded program for program deletion decisions, the method comprising:
associating a deletion rule with a recorded program wherein the deletion rule is based on viewer activity information; and
deleting the recorded program based on viewer activity information.

23. A system for maintaining viewer activity information of a recorded program for program deletion decisions comprising:
means for storing viewer activity information for a recorded program; and
means for displaying the viewer activity information of the recorded program when a user is prompted on whether to delete the recorded program.

24. The system of claim 15 further comprising:
means for prompting each viewer of the recorded program to indicate that the viewer has viewed the recorded program and storing the indication for each viewer as viewer activity information for the recorded program.

25. The system of claim 16 further comprising:
means for storing a list of prospective viewers.
wherein means for prompting each viewer of the recorded program to indicate that the viewer has viewed the recorded program comprises means for displaying the list of prospective viewers and prompting each viewer of the recorded program to indicate that the viewer has viewed the recorded program.

26. A system for maintaining viewer activity information of a recorded program for program deletion decisions comprising:
means for storing viewer activity information for a recorded program; and
means for deleting the recorded program based on the viewer activity information.

27. The system of claim 18 further comprising means for associating a deletion rule with the recorded program wherein the deletion rule is based on the viewer activity information.

28. The method of claim 18 further comprising:
means for storing a list of prospective viewers;
means for displaying the list of prospective viewers and prompting each viewer of the recorded program to indicate that the viewer has viewed the recorded program; and
means for storing the indication for each viewer as viewer activity information for the recorded program.
